(19) United States
(12) Patent Application Publication
(10) Pub. No.: US 2014/0137713 A1
(43) Pub. Date: May 22, 2014

(54) APPARATUS AND METHOD FOR CUTTING BIOSPECIMEN AND CELL OBSERVATION METHOD

(71) Applicants: Tsukasa Matsumoto, Tokyo (JP); DAStech, Inc., Saitama (JP)

(72) Inventors: Shunji YOSHIDA, Saitama (JP); Nobuyuki TAKAHASHI, Saitama (JP); Tsukasa MATSUMOTO, Tokyo (JP)

(73) Assignees: DAStech, Inc., Saitama (JP); Tsukasa Matsumoto, Tokyo (JP)

(21) Appl. No.: 14/071,376

(22) Filed: Nov. 4, 2013

(30) Foreign Application Priority Data
Nov. 20, 2012 (JP) 2012-254175

(51) Int. Cl. G01N 1/06; G01N 1/42

(52) U.S. Cl. CPC G01N 1/06; G01N 1/42
USPC 83/15; 83/170

(57) ABSTRACT

An apparatus for cutting a workpiece as biospecimen into a section while maintaining living state of cells includes a board on which the workpiece is placed, a device for freezing and fixing the workpiece on the board, and a blade for cutting the frozen workpiece fixed on the board into a section by means of rotary movement in a predetermined rotational direction. A profile of a cutting edge of the blade is a curve showing monotonic increase in distances of a rotational axis to points starting at a nearest point that is the shortest from the axis and ending at a farthest point that is the longest from the axis. The farthest point is behind the nearest point in the rotational direction and the curve is convex opposite to the rotational axis with respect to a straight line connecting the nearest point and the farthest point.

### CROSS-REFERENCE TO RELATED APPLICATION

This application claims priority to Japanese Patent Application No. 2012-254175, filed on Nov. 20, 2012, which is hereby incorporated by reference.

### BACKGROUND OF THE INVENTION

The present invention relates to an apparatus for and method for cutting a frozen biospecimen containing cells and tissues into a section or a thin slice and to a method for cell observation.

### DESCRIPTION OF THE RELATED ART

Conventionally in a technical field of biology and medical science, an apparatus for freezing and cutting a biospecimen into a section is known. A biospecimen is, for example, material taken from humans, animals, or plants, which is part of internal organs or a body and normally contains one or a plurality of tissues. Such tissue has a specified structure formed by a collection of several kinds of cells.

Japanese laid-open publication No. 2011-232299 discloses a frozen thin-section manufacturing apparatus for diagnosis of site of lesion in a short time during surgery. The apparatus is provided with a rotary microtome (tool to cut thin slices) in a refrigerator at a temperature of around −10° C. to −30° C. In the apparatus, in order to prevent tissue destruction caused by aqueous volume expansion in gradual freezing of cells, moisture in cells are supercooled by means of microwave irradiation and then instantly frozen by halting the irradiation. The tissue obtained by instantly freezing the cells as above is cut with the rotary microtome into a thin-section, such as 5 μm to 10 μm, and is made available for diagnosis with microscopy.

On the other hand, in a technical field of machining, which is totally different from the above, apparatuses for and methods of freezing and fixing a workpiece to be processed with milling and grinding are known. Japanese laid-open publications No. 2007-30059 and No. 2007-237376 disclose a method wherein liquid or viscous coagulant (e.g., hydrosoluble polymer) is arranged between a workpiece and a board, the workpiece is processed with a machining tool after freezing and fixing with the coagulant frozen at a temperature of 5° C. to 15° C.

The apparatus disclosed in the first related art is directed to complete steps from collecting through cutting to diagnosing a biospecimen in such a sort time as a few minutes to tens of minutes. However, this apparatus is not applicable to general biospecimens (some biospecimens are preserved for long period of time). Also, this method cannot be commonly used due to special equipment required for microwave irradiation.

A microtome, which is a well-known cutting apparatus as used in the first related art, generally affords temperature up to about −50° C. at the most for freezing. It is said that cells in a biospecimen can be preserved almost permanently without causing deterioration only if they are maintained at liquid nitrogen temperature, and that deterioration in cells progresses at temperature higher than that of liquid nitrogen. Further in microtomy, embedding and freezing by using paraffin etc. are necessary prior to cutting of biospecimen, depending largely on a worker's skill. As a result, it is not so easy that anyone can prepare a specimen in good condition for observation. Also in microtomy, cell function that is active when in a living body is damaged causing what is called dead cells. This is due to pretreatment (e.g., formalin treatment or paraffin treatment after dehydration) required for fixing a specimen. In general utilization technology of microtome, it takes time, such as five days, from starting of preparation through cutting of specimen to observing of cells, which requires substantial personnel and time costs.

As to a freezing and cutting device in the field of machining as stated the second and third related art, if applied to cutting of biospecimen as it is, cells are damaged due to higher freezing temperature and the use of a disc blade which is commonly used in machining. That is, after the biospecimen is cut by a cutting edge of disc blade, longer contact time between the cutting surface of the biospecimen and the side of the blade creates friction to heat the cutting surface, resulting in deterioration or deformation in cells. This is true of a case wherein a biospecimen is cut with linear movement of a razor-like edge.

The present invention addresses the problems discussed above, and aims to provide an apparatus for and a method for cutting a biospecimen into a section, in which the specimen is cut into a section such as several μm to tens of μm while maintaining tissues and cells in the biospecimen in the same state as they were in an original living body without causing deterioration or deformation. In addition, the present invention aims to surely cut a biospecimen, whether it be a fresh specimen that has just been collected or an old specimen that has been preserved for a long time, with only easy pretreatment performed in a short time.

### BRIEF SUMMARY OF THE INVENTION

The present invention provides the following constitution to achieve the above stated aims. According to a first aspect of the present invention, an apparatus for cutting a workpiece as biospecimen into a section comprises: a board on which the workpiece is placed; a device for freezing and fixing the workpiece on the board; and a blade for cutting the frozen workpiece fixed on the board into a section by means of rotary movement in a predetermined rotational direction. In this apparatus, a profile of a cutting edge of the blade is a curve starting at a nearest point from a rotational axis and ending at a farthest point from the axis wherein the distance from the axis to each of the points on the curve increases monotonically from the nearest point to the farthest point; the farthest point is behind the nearest point in the rotational direction; and the curve is convex opposite to the rotational axis with respect to a straight line connecting the nearest point and the farthest point.

In the first aspect, it is preferable that a cryogenic liquid is used in the device for freezing and fixing. It is also preferable that the cryogenic liquid is supplied to the workpiece during cutting operation by the blade and that such cryogenic liquid is liquid nitrogen.

According to a second aspect of the present invention, a method for cutting a workpiece as biospecimen into a section comprises the steps of: placing the workpiece on a board; freezing and fixing the workpiece on the board; and cutting the frozen workpiece fixed on the board into a section by means of rotary movement of a blade in a predetermined rotational direction. In this method, a profile of a cutting edge of the blade is a curve starting at a nearest point from a rotational axis and ending at a farthest point from the axis wherein the distance from the axis to each of the points on the curve increases monotonically from the nearest point to the farthest point; the farthest point is behind the nearest point in the rotational direction; the curve is convex opposite to the rotational axis with respect to a straight line connecting the nearest point and the farthest point.

In the second aspect, it is preferable that a cryogenic liquid is used in the step of freezing and fixing. It is also preferable that the cryogenic liquid is supplied to the workpiece during cutting operation by the blade and that such cryogenic liquid is liquid nitrogen.

A further aspect of the present invention is a section cut out from the biospecimen by using the cutting method according to the second aspect of the present invention.

According to a further aspect of the present invention, a method for cell observation comprises the steps of preparing a section of biospecimen by using the method for cutting a biospecimen according to the second aspect of the present invention and observing cells contained in the section with a phase-contrast microscope while the section is immersed in a tissue culture growth medium. It is preferable that the observation further has a step of observing cells contained in the section with a phase-contrast microscope while continuing culture with the tissue culture growth medium containing the immersed section being kept in a carbogaseous incubator.

According to a further aspect of the present invention, a method for cell observation comprises the steps of preparing a section of biospecimen by using the cutting method according to the second aspect of the present invention and observing cells contained in the section, which are taken out from the tissue culture growth medium after immersion and then stained.

According to the cutting apparatus and the cutting method for the present invention, a workpiece as biospecimen fixed on a board is cut by rotation of a blade having a specific profile. Unlike a conventional disc blade, a combination of the profile of the blade with rotational motion makes it possible to prevent longer contact time between the cutting surface of the workpiece and the blade. Consequently, it is possible to prevent cells in the biospecimen from being deteriorated or deformed by friction with the blade.

According to the present invention, a workpiece is cut after it is instantly frozen and fixed on the board by using a liquid for freezing and fixing, requiring no pretreatment that has been conventionally required but damages the function of cells in the biospecimen. Consequently, in the biospecimen that was cut into a section by applying the present invention, cells or tissues are kept in the same state (as for their position and function) as presented in a living body. That is, the position of the cells when formed tissues in the living body is maintained as it is and functions including proliferation, repair, metabolism, and transducing signals among cells, are maintained as they are. Cells in this state are defined in this specification as “living cells”. In order to maintain this state, a workpiece as biospecimen is maintained at a temperature of a liquid for freezing and fixing during cutting process and the workpiece is cut by using rotational motion of a blade having a specific profile.

The present invention allows to use a biospecimen that is cut into a section, for example, several μm to tens of μm thick, as a specimen in cell observation for research, or as a product or material thereof in various fields such as biology, biochemistry, medicine, and pharmacy since such biospecimen is formed with living cells.

The present invention further allows to shorten the time from preparation to observation of biospecimen to about an hour whereas conventional cell observation requires several days. This leads to reducing time and personnel costs significantly.

### BRIEF DESCRIPTION OF THE DRAWINGS

FIG. 1A shows a front view schematically illustrating a main part of a cutting apparatus for biospecimen according to an embodiment of the present invention.

FIG. 1B shows a side view schematically illustrating a main part of a cutting apparatus for biospecimen according to an embodiment of the present invention.

FIG. 2A shows a time-series schematic view illustrating a blade cutting a workpiece in the embodiment shown in FIGS. 1A-1B.

FIG. 2B shows an example of cross-section A shown in FIG. 2A.

FIG. 3 shows a schematic view illustrating a profile of a cutting edge of a blade in a cutting apparatus.

FIGS. 4A-4B show different examples of profile requirement for the cutting edge of the blade illustrated in FIG. 3.

FIGS. 5A-5F show different examples of profile requirement for the cutting edge of the blade illustrated in FIG. 3.

FIGS. 6A-6C show different examples of profile requirement for the cutting edge of the blade illustrated in FIG. 3.

FIGS. 7A-7B show a process of a method for cutting biospecimen according to an embodiment of the present invention.

FIG. 8 shows a general front view of an example of an entire apparatus for the method for cutting bipospecimen illustrated in FIGS. 7A-7B.

FIG. 9 shows a schematic side view illustrating a section of biospecimen cut out by using a cutting apparatus and a cutting method according to an embodiment of the present invention.

FIG. 10 shows a micrograph of a 25-μm-thick section cut out from a rat liver with an apparatus according to an embodiment of the present invention.

### DETAILED DESCRIPTION

Preferred embodiments of the present invention will be described with reference to the accompanying drawings.

The term “biospecimen” as used herein is intended to define material containing cells or tissues that are harvested from humans, animals or plants. When the present invention is applied to a biospecimen containing living cells, the cells contained in a thawed section after cutting still remain in the same state as they were originally in the biospecimen, that is, maintaining a living state. It should be noted, however, that the present invention may be applied not only to a biospecimen wherein cells are in a living state but also to a biospecimen wherein cells are in a non-living state or in various other states.

A biospecimen to which the present invention is applied is, for example, a biospecimen shortly after it is harvested from a living body or a biospecimen that has been accordingly preserved for a predetermined period of time. In the latter case, it is not limited to a specific preserving method. A preferable biospecimen is that has been preserved after instant freezing with liquid nitrogen, which is said to be capable of preserving cells almost permanently. The present invention may also be applicable to a biospecimen that is frozen with a cryogenic liquid other than liquid nitrogen. It is said to be possible to preserve a biospecimen at a temperature of about −80° C. for months to a year, to which the present invention is applicable.

The above-described bispecimens are defined as a “workpiece (an object to be processed)” to be cut in a cutting apparatus and method according to an embodiment of the present invention.

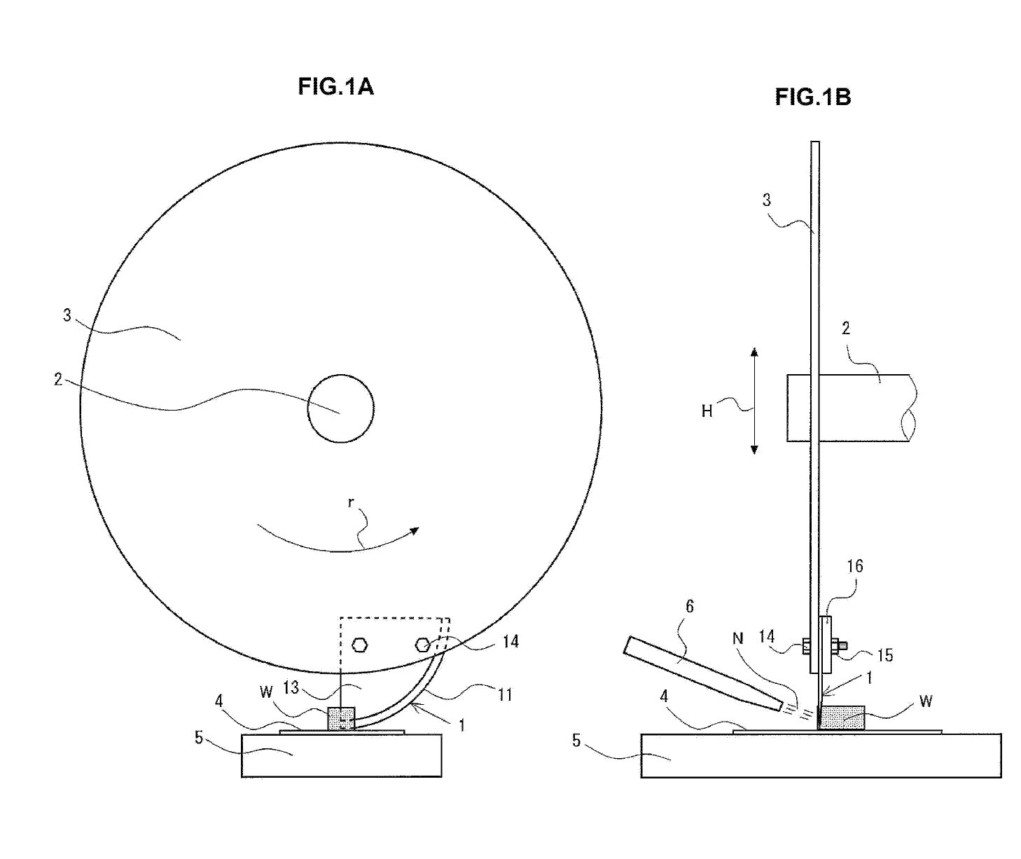

FIG. 1A shows a front view schematically illustrating a main part of a cutting apparatus for biospecimen according to an embodiment of the present invention and FIG. 1B shows a side view schematically illustrating a main part of a cutting apparatus for biospecimen according to an embodiment of the present invention.

FIGS. 1A-1B show a workpiece W being cut with a blade 1. In FIGS. 1A-1B, the workpiece W is substantially cuboid and is placed on a board 4 laid on an even table 5. The workpiece W is frozen and fixed on the board 4 by being subject to dripping liquid for freezing and fixing just before it is cut. The liquid for freezing and fixing is preferably a cryogenic liquid, typically liquid nitrogen (−196° C.). As other cryogenic liquid, methane (−163.0° C.), liquid oxygen (−186.0° C.), liquid hydrogen (−252.8° C.) may be used for freezing and fixing. As an example, a case of liquid nitrogen is described hereinafter.

The table 5 is movable to move the workpiece W or change its orientation. The even top face of the board 4 is the fixing surface. The board 4 may be any material as long as its flatness can be maintained at a temperature of liquid nitrogen and made from among, fluororesin, PET, glass, metal, etc. The thickness of the board 4 is, for example, approx. 200 μm to 300 μm.

In the example shown in FIGS. 1A-1B, a workpiece W being cut remains still and the blade 1 projects outward from a part of rim of a disk-shaped support 3. The blade 1 is attached to the support 3 by using fixing bolts 14, fixing nuts 15, and a locking plate 16. A method for attaching blade 1 is not limited to the example in the Figure. Substantive cutting function of the blade 1 lies in a cutting edge 11 projecting from the rim of the support 3. The support 3 is concentrically attached to a rotational axis member 2. Rotation of the rotational axis member 2 leads to rotation of the cutting edge 11 of the blade 1 to cut the workpiece W into a section. Reference symbol r is indicative of rotational direction of the blade 1. In one example, the blade 1 is rotated by hand, e.g., a handgrip for rotating the rotational axis member 2 is slowly rotated by hand. In other example, the blade 1 may be rotated with an electric motor. A rotation speed of the blade 1 is optional; however, low-speed rotation, which is almost the same level as rotation generated by hand, is preferable. This is to prevent the workpiece W from coming off the board 4 due to lateral wobbling or vibration of the blade 1 during rotation.

The thickness of a section can be determined in accordance with the positional relation of the workpiece W with the blade 1. This setting, as described hereinafter, is adjusted with the movement of the table 5. A given thickness, for example, 5 μm, 10 μm, 30 μm, etc. can be obtained. The thickness of a section to be used for cell observation with an optical microscope is normally about several μm to tens of μm.

In order to obtain one section surely separated from the rest of the workpiece W, the height of the blade 1 is adjusted. This adjustment is performed by adjusting the height of the rotational axis member 2 (refer to arrow H shown in FIG. 1B).

It is preferable to supply liquid nitrogen from a liquid nitrogen supplying device 6 in order to prevent temperature of the workpiece W and the board 4 from rising during cutting operation. Only a nozzle part of the liquid nitrogen supplying device 6 is shown in FIG. 1B, but a tank that is not shown in FIGS. 1A-1B supplies liquid nitrogen. The liquid nitrogen supplying device 6 is placed at a position that does not disturb cutting operation of the blade 1.

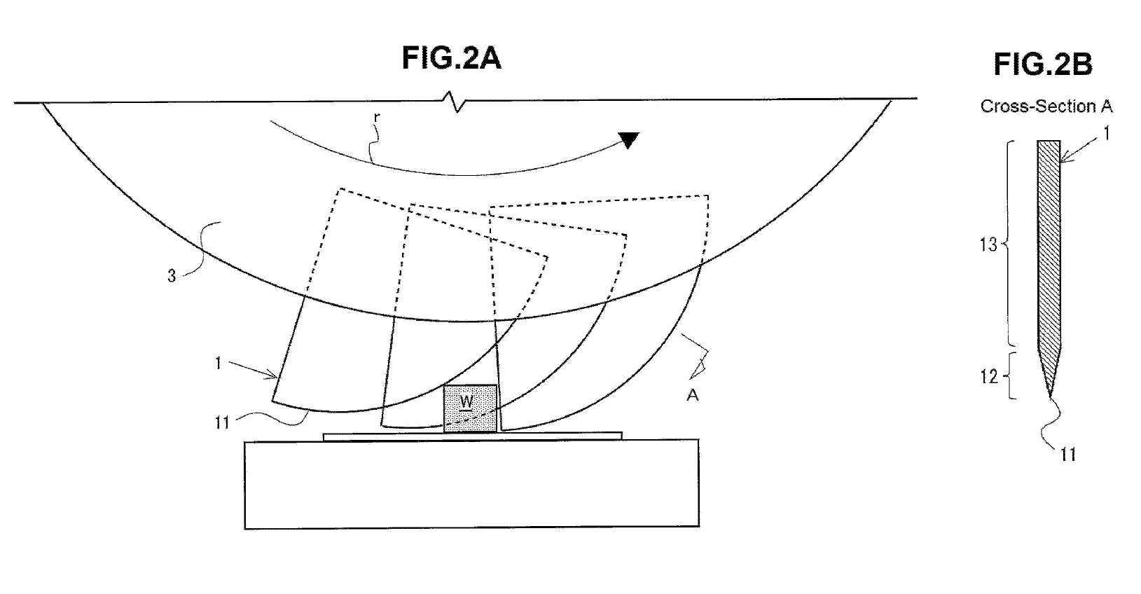

FIG. 2A shows a time-series schematic view illustrating a blade 1 cutting a workpiece W in the embodiment shown in FIGS. 1A-1B. FIG. 2B shows an example of cross-section A, i.e., cross-section of the blade 1 shown in FIG. 2A.

FIG. 2A shows that the cutting edge 11 of the rotating blade 1 goes into from the upper edge of the workpiece W and goes through it after cutting the entire workpiece. The lowest point of passage of the cutting edge 11 almost accords with the bottom face of the workpiece W. In order to achieve this accordance, the height of the blade 1 is determined.

In a preferred example, it is preferable as shown to apply a small amount of coagulant 7 to the surface of the board 4 (refer to the third related art). Preferable example of coagulation 7 is viscous hydrosoluble polymer such as polyvinyl alcohol, starch, sodium alginate, carboxymethyl cellulose. Fundamental role of the coagulant 7 is to temporarily hold the workpiece W prior to freezing and fixing. Further, placing the workpiece W on the coagulation 7 causes the workpiece W to be raised from the surface of board 4 by the thickness of the coagulant 7. In this case, as shown, adjusting the height of blade 1 so that the cutting edge 11 of the blade 1 gets into the coagulant 7 makes it possible for the cutting edge 11 to surely cut the workpiece W as a whole. If the coagulant 7 is not applied, height adjustment of the blade 1 requires significantly high accuracy to prevent the cutting edge 11 from touching the surface of the board 4. However, applying the coagulant 7 gives margin in adjusting the height of the blade 1 due to the thickness of coagulant 7.

As shown in the sectional view A of FIG. 2B, the blade 1 has a cutting edge 11 at its tip, a cutting blade 12 tapering toward the edge 11, and a flat part 13. The blade 1 is double edged in this example but may be single edged.

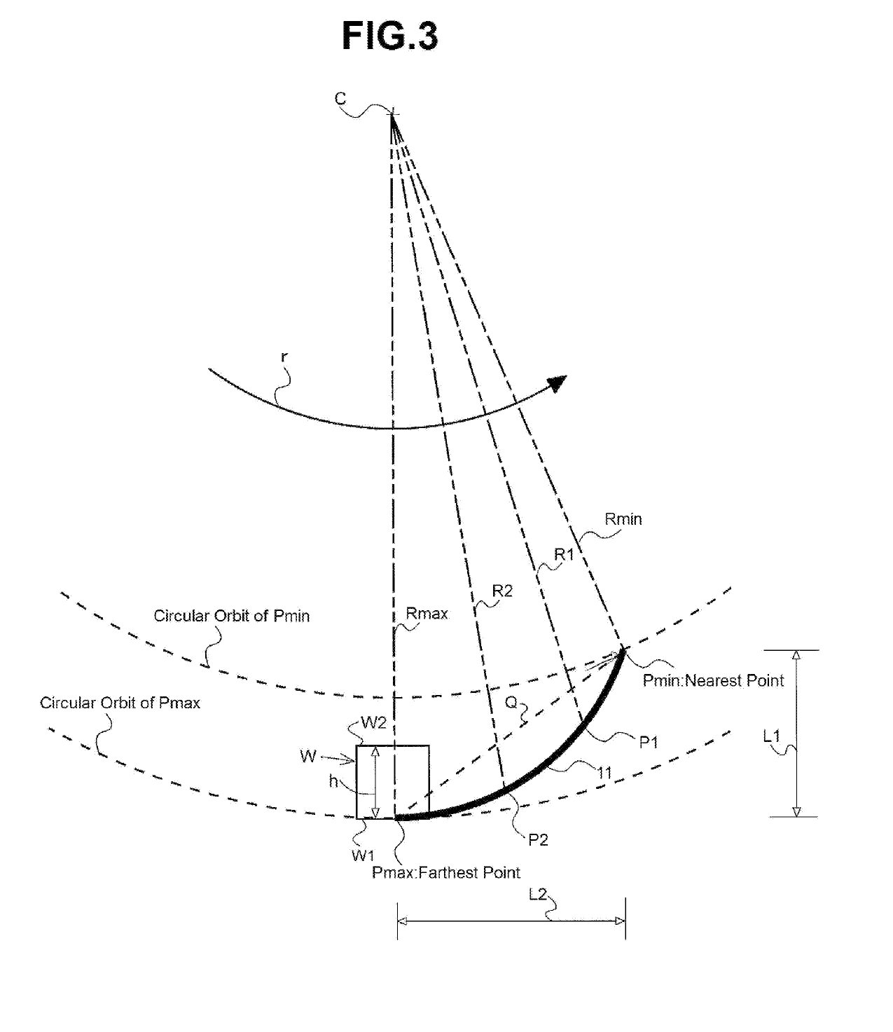

FIG. 3 shows a schematic view illustrating a profile of a cutting edge 11 of a blade in a cutting apparatus according to an embodiment of the present invention. The cutting function of the blade substantially lies in the cutting edge 11. Rotary movement of the blade 11 having a preferable profile in a predetermined rotational direction r allows to cut the workpiece W as biospecimen while maintaining living state in cells. FIG. 3 shows only the cutting edge 11 in bold without showing the blade as a whole.

Reference symbol C is indicative of a rotational axis, i.e., rotational center. The cutting edge 11 has a specified curved profile extending between a first end and a second end.

The first end of the cutting edge 11 is a point which has the shortest distance Rmin from the rotational axis C (hereinafter referred to as a “nearest point Pmin”). The second end of the cutting edge 11 is a point which has the longest distance Rmax from the rotational axis C (hereinafter referred to as a “farthest point Pmax”). The cutting edge 11 has a curved profile extending from the first end to the second end. The farthest point Pmax is behind the nearest point Pmin in the rotational direction r. Along with the cutting edge 11, the distance from the rotational axis C to each of points on the edge 11 monotonically increases starting from the nearest point Pmin to the farthest point Pmax. For example, if the distance between the rotational axis C and a given point P1 on the edge 11 is determined as R1 and the distance between the rotational axis C and a given point P2 on the edge 11 is determined as R2, their inequality is expressed as Rmin<R1<R2<Rmax.

The curved profile of the cutting edge 11 has convex opposite to the rotational axis C with respect to a straight line Q connecting the nearest point Pmin and the farthest point Pmax (outward in radius direction seen from the axis C). The curve of the cutting edge 11 is a circular arc in FIG. 3, which may be an elliptical arc or other curve such as a parabola or a higher-degree curve.

The following are some examples of dimensions of the cutting edge 11 shown in FIG. 3:

distance Rmin from the rotational axis C to the nearest point Pmin: 40 mm to 6 mm (distance Rmin equals to the radius of the circular support 3 in the example of FIGS. 1A-1B)

distance Rmax from the rotational axis C to the farthest point Pmax: 50 mm to 75 mm

length L1 of the cutting edge 11 in longitudinal direction: 10 mm to 15 mm

length L2 of the cutting edge 11 in lateral direction: 18 mm to 30 mm (longitudinal direction L1 and lateral direction L2 are referred to at the moment when the farthest point Pmax hits the lowermost point as shown in FIG. 3)

height h of the workpiece W: 5 mm to 8 mm

When the cutting edge 11 rotates in rotational direction r, it is possible to cut an object placed within a plane through which the cutting edge 11 moves across. The plane is an annular plane bounded by two circular orbits that are created with the nearest point Pmin and the farthest point Pmax as shown in dotted lines. This plane is hereinafter referred to as an “area feasible for cutting.” In order to cut the workpiece W into a section, it is required to place the workpiece W such that a cross-section of the workpiece W is almost within the area feasible for cutting. A preferable example of positioning is, as shown in FIG. 3, the center of the bottom face W1 of the workpiece W is aligned with the lowermost point of the farthest point Pmax (lowermost point in vertical direction). And then, the height h of workpiece W is determined such that the top face of W2 of the workpiece W is lower than the circular orbit of the nearest point Pmin.

Speaking accurately, there may be some area near both right and left edges of the bottom face W1 of the workpiece W, to which the cutting edge 11 does not reach and cut sufficiently for the reason of circular orbit created by the farthest point Pmax as shown in FIG. 3. This problem is solved by raising the bottom face W1 of the workpiece W owing to application of the coagulant 7 on the board 4 as explained with FIGS. 2A-2B.

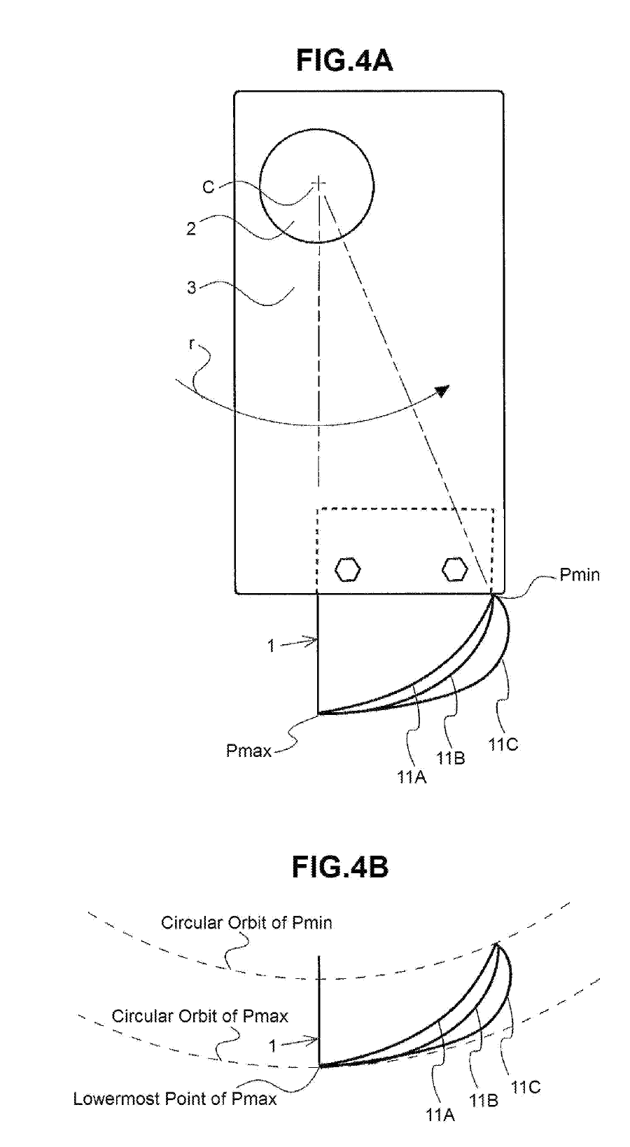

FIGS. 4A-4B, FIGS. 5A-5F, and FIGS. 6A-6C show different examples satisfying the profile requirements for the cutting edge 11 of the blade 1 illustrated in FIG. 3.

As to three examples of cutting edges 11A, 11B, 11C shown in FIG. 4A, the position of the nearest point Pmin and the farthest point Pmax is identical but profiles of curve between the two points are different. Reference symbol 11A shows a small curve. Reference symbol 11B shows an elliptical arc. Reference symbol 11C shows a curve arching out ahead in the rotational direction r. FIG. 4B shows circular orbits of the nearest point Pmin and the farthest point Pmax created by rotary movement of three types of cutting edges shown in FIG. 4A. As to the three cutting edges, the position of the nearest point Pmin and the farthest point Pmax is identical, and their circular orbits are identical.

As shown in FIG. 4A, the support 3 to which the blade 1 is attached must not necessarily be a disk shape as shown in FIG. 1A. The support 3 is a substantially rectangular shape in FIG. 4A, and other shape will do as long as such support 3 rotates integrally with the rotational axis member 2 and the blade 1 (substantially its cutting edge 11) can be attached to a given position.

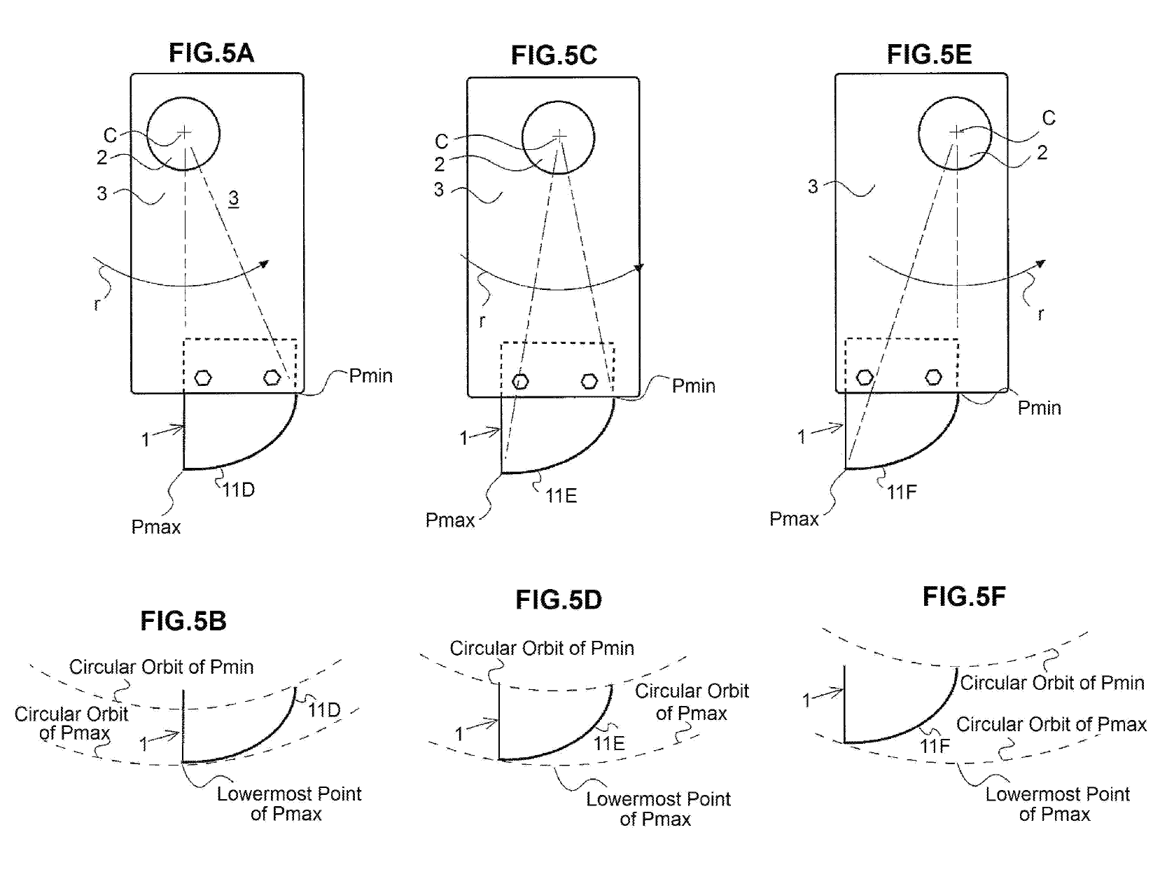

FIGS. 5A-5F show three examples of different attachment position of the blade 1 with respect to the rotational axis C. As to the cutting edge 11D, 11E, and 11F of the blade 1 shown in FIG. 5A, FIG. 5C, and FIG. 5E, respectively, their profiles are identical but their attachment positions with respect to the rotational axis C are different. Different attachment positions lead to different distances from the rotational axis C to the nearest point Pmin and to the farthest point Pmax. FIG. 5B, FIG. 5D, and FIG. 5F show circular orbits of the nearest point Pmin and the farthest point Pmax created by rotary movement of respective cutting edges that are shown as FIG. 5A, FIG. 5C, and FIG. 5E, respectively. The area through which the cutting edge moves across, i.e., the range of the area feasible for cutting, differs according to the attachment position of the cutting edge.

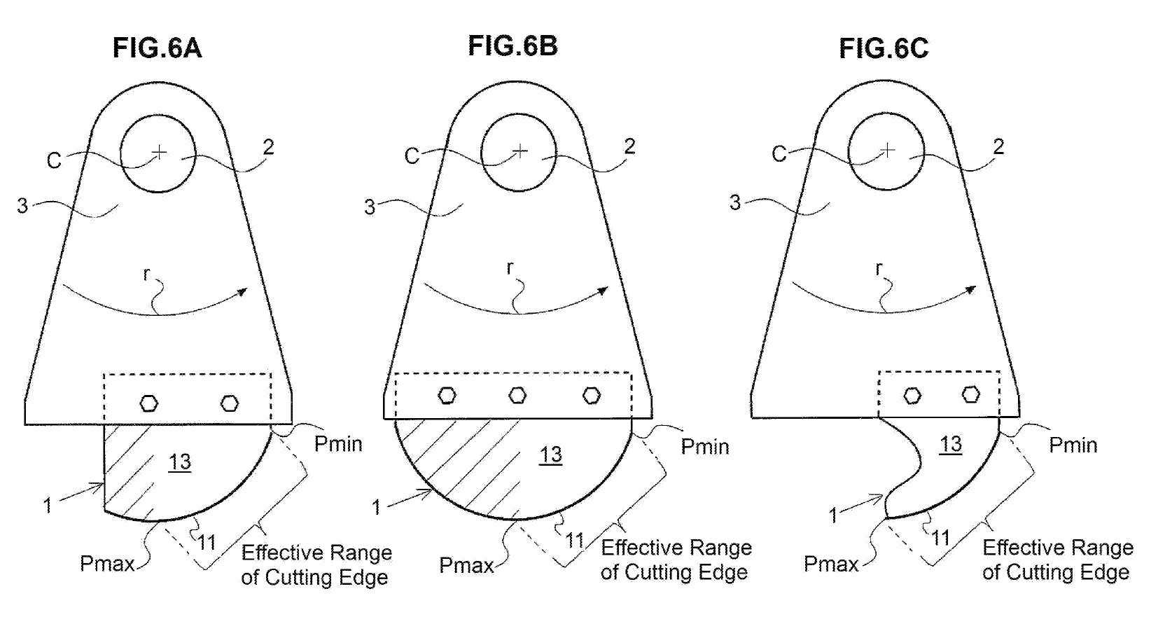

FIG. 6A, FIG. 6B, and FIG. 6C show examples of other profiles of the blade 1. In FIG. 6A and FIG. 6B, the flat part 13 of the blade 1 has an extended area (hatching area) that extends backward from the farthest point Pmax. The area behind the farthest point Pmax may be provided with an edge as an extended area of the edge 11; however, such area of the edge does not contribute to cutting operation. The effective range of the cutting edge 11 for cutting operation is, as shown, only a range between the nearest point Pmin and the farthest point Pmax.

During the rotation of the blade 1, the flat part 13 extending from the cutting edge 11 rotates making contact with the cutting surface of the workpiece after the cutting edge 11 cut the workpiece W. Accordingly, the larger the area of the flat part 13, the longer the contact time with the workpiece, resulting in possibilities of temperature rise or damage in the workpiece caused by friction with the cutting surface. Considering these possibilities, a profile, as respective blades shown in FIGS. 4A-4B and FIGS. 5A-5F, wherein the flat part 13 is not present behind the farthest point Pmax is preferable. Further, as shown in FIG. 6C, the back rim of the flat part 13 may be cut out forward in the rotational direction r. In this regard, however, the profile and the area of the flat part 13 should be properly designed since the cutting edge 11 cannot be stably held if the area of the flat part 13 is too small.

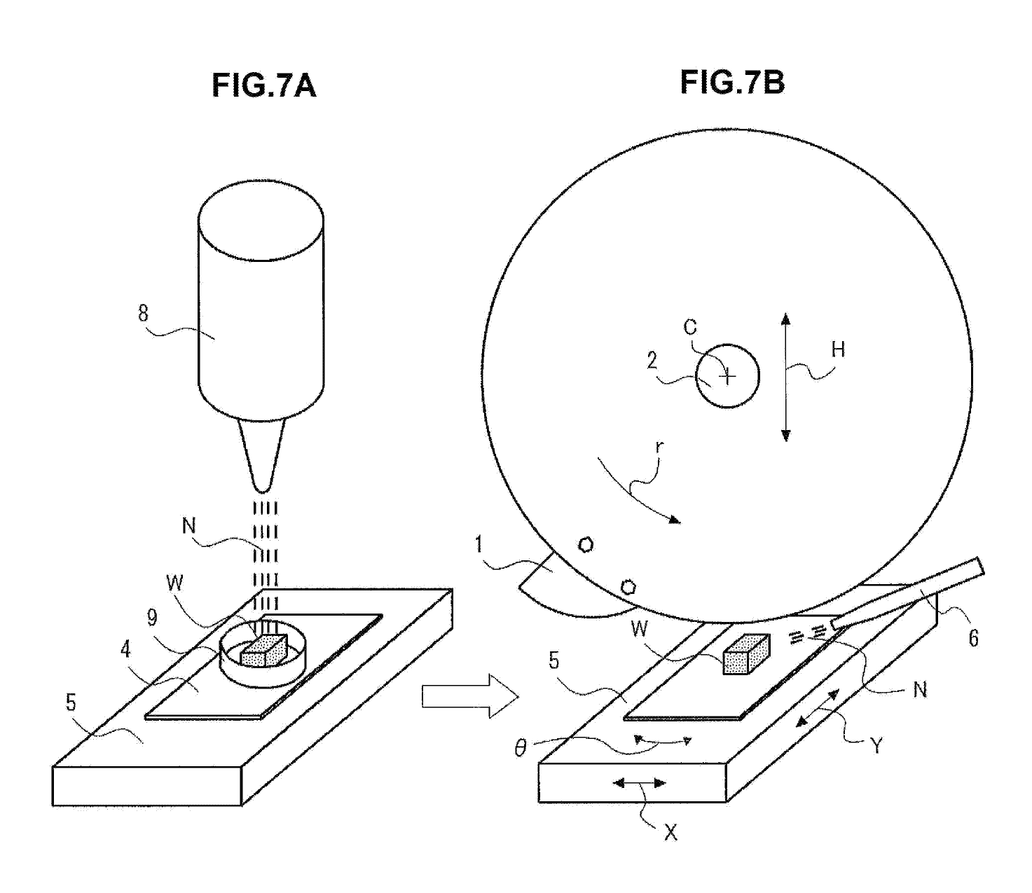

FIGS. 7A-7B show a process of a method for cutting biospecimen according to an embodiment of the present invention. An example using liquid nitrogen will be hereinafter described; however, other cryogenic liquid may be used.

### Process of Harvesting Biospecimen

A proper size of specimen is cut from part of internal organs or the body of a living body of humans or animals. Cells contained in the specimen are at the living state as described above. The size of the specimen should be sufficient to obtain a workpiece for cutting. If cutting operation according to the present invention is performed immediately, the next process is <Process of preparing for workpiece> described below. If not, the specimen is immediately frozen with liquid nitrogen and then preserved being kept at the temperature of liquid nitrogen. In this preservation method, which is known well, the preserved specimen can maintain the living state of cells almost permanently.

### Process of Preparing for Workpiece

This process is performed in a clean room provided with required equipment. In case of a specimen just after being cut, it is frozen immediately by means of dripping of or immersing in liquid nitrogen and is cut into a proper size of workpiece from the frozen portion. In case of a specimen kept at nitrogen temperature, it is immediately cut into a proper size of workpiece while keeping the temperature as much as possible.

The size appropriate for a workpiece to be cut and the horizontal and vertical length of the cutting surface are determined based on the size of the area feasible for cutting of the cutting edge of the cutting apparatus. As an example with reference to FIG. 3, if the lowermost position on the circular orbit of the nearest point Pmin is 8 mm in height from the board, the cutting surface of the workpiece is set as a 5 mm square. Though the depth of the workpiece in FIG. 3 is arbitrary, it is relevant to the dimensions of the fixed surface of workpiece with respect to the board 4, and insufficient depth fails to fix stably making stable cutting difficult. In this example, the depth is set at around 10 mm. In this way, a workpiece in the shape of a cuboid 5 mm in height, 5 mm in width, 10 mm in depth is cut out. The workpiece is at the state of being frozen with liquid nitrogen.

### Process of Freezing and Fixing the Workpiece on the Board

As shown in FIG. 7A, a liquid nitrogen dripping device 8 having a dripping nozzle beneath a container filled with liquid nitrogen is adjusted at a proper height. The table 5 and the board 4 are moved to place under the liquid nitrogen dripping device 8. The table 5 and the board 4 are in advance cooled to around −30° C. As previously described, applying coagulant on the board 4 is preferable. The coagulant is viscous and capable of fixing the workpiece W temporarily on the board. It is preferable to use sterilized coagulant. It is also preferable to set the thickness of coagulant to the extent that it can raise the bottom of the workpiece W from the surface of the board 4.

The frozen workpiece W cut out to a given size is placed on the board 4 applied with coagulant so as to be directly under the dripping nozzle of the liquid nitrogen dripping device 8. An antiscattering ring 9, which is aimed to prevent dripping liquid nitrogen N from scattering, is placed around the workpiece W. And then, liquid nitrogen N is dripped from the liquid nitrogen dripping device 8, the amount of which is adjustable. Any device or tool having other figures than the liquid nitrogen dripping device 8 as shown may be used as long as it is capable of supplying the workpiece W and the board 4 with liquid nitrogen. This dripping of liquid nitrogen N makes it possible to further freeze and fix the workpiece W, which has already been frozen itself, on the board 4 instantly. In this freezing and fixing, the strength of fixing is to the extent of preventing the workpiece W from coming off the board 4 during cutting process that will be described hereinafter.

A series of operations from cutting out of the workpiece W through placing on the board 4 to dripping of liquid nitrogen N is performed as quickly as possible in order to prevent temperature rise in the frozen workpiece.

### Process of Moving the Table

The table is moved in direction X from the position as shown in FIG. 7A to the position as shown in FIG. 7B (refer to void arrow in the Figure). The workpiece W is placed directly under the rotational axis member 2 of the cutting apparatus as shown in FIG. 7B. At this stage, the rotational axis member 2 of the cutting apparatus is raised with height adjustment H and the blade 1 is placed waiting for cutting away from a cutting position with sufficient angle.

### Process of Positioning

Following the above, positioning is performed for properly placing the workpiece W. Horizontal positioning is determined by parallel movement of the table 5 in X and Y directions and rotational movement in θ direction. Such movement function of the table 5 may be operated manually or by an electric motor. An electric motor equipped with control function that is capable of setting the quantity of movement is preferable. The movement in X direction is for placing the workpiece W directly under the rotational axis C of the blade 1. The movement in Y direction is for determining a starting point of cutting and the thickness of a section to be cut out from the workpiece W. The rotational movement in θ direction is for adjusting warping and orientation of the workpiece W when frozen. Lastly, the rotational axis member 2 is lowered to the cutting point. At this stage, the blade 11 is still away from the workpiece W not contacting with the workpiece W.

### Process of Cutting

Rotation of the rotational axis member 2 enables the blade 1 to rotate in rotational direction r resulting in cutting the workpiece W. The blade 1 may be rotated manually or by an electric motor. During the positioning and cutting processes, a proper amount of liquid nitrogen is supplied from a liquid nitrogen supplying device 6 to prevent temperature rise in the workpiece W and the board 4. Liquid nitrogen may be supplied continuously or intermittently. After the blade 1 passes through the workpiece W and cut it into a section, the section lies down onto the board 4.

In the embodiment of FIGS. 7A-7B, the workpiece W remains still during rotation of the blade 1. In another embodiment, the workpiece W may be moved parallel from right to left in X direction during rotation of the blade 1. In another embodiment, the rotational axis C may be moved parallel from left to right in X direction during rotation of the blade 1. In these another embodiments, the cutting edge 11 moves in combination of circular motion with linear motion with respect to the workpiece W. Accordingly, the farthest point Pmax of the cutting edge 11 moves from the left end to the right end along with the bottom of the workpiece W (refer to FIG. 3). This eliminates an area to which the cutting edge 11 does not reach in the neighborhood of the bottom of the workpiece W. In this case, raising the bottom of the workpiece W with coagulant is not necessary and such coagulant is used mainly for temporarily fixing.

### Preparation for Next Cutting Process

If a next section is cut subsequently, the blade 1 is rotated in rotational direction r to return to the waiting position shown in FIG. 7B, and the workpiece W is moved in Y direction to the amount in accordance with the thickness of the next section. The lower limit of thickness of a section feasible for cutting depends on various conditions such as the thickness of flat area or the length of cutting blade of the blade 1. For example, if the thickness of flat area of the blade 1 is approx. 200 μm to 250 μm, cutting of a section to a few μm is possible, which has been confirmed in experiment.

### Aftertreatment of the Section

The section lied down onto the board 4 is taken out with tweezers and immediately immersed in tissue culture growth medium. This is for protecting and unfreezing the section. A plurality of sections may be taken out in bulk after continuous cutting. Liquid nitrogen may be supplied to the section just before being taken out to prevent temperature rise during transfer to the tissue culture growth medium.

### Method for Cell Observation

The section of biospecimen that is unfrozen in the tissue culture growth medium as described above, is provided, for example, for cell observation as follows.

### Observation Method 1

Cells that are existing in the section in the state of being immersed in the tissue culture growth medium in a container are observed from outside the container with a phase-contrast microscope.

### Observation Method 2

Following the above observation 1, the container containing the section immersed in the tissue culture growth medium is further kept in a carbogaseous incubator (e.g., at 37° C., 5% of carbon dioxide concentration) while continuing culture. During this state, cells that are existing in the section are observed from outside the container with a phase-contrast microscope. This observation can be continued as long as the cells in living state are preserved, and applicable to, for example, a case in which effects on cells with chemical agent added in the medical and pharmaceutical fields are studied.

### Observation Method 3

The section in the tissue culture growth medium is taken out, and then cells in the section are stained to observe with a microscope.

Conventionally a cell observation method requires formalin treatment, alcohol (100%) treatment, and paraffin embedding treatment, etc. applied to a biospecimen before cutting out a section, followed by staining. In such conventional method, it takes time and operation is complicated and various treatment agents are necessary, further, observation of living cells is not possible. On the other hand, application of the present invention makes it possible to cut out a section with short time and easy operation without requiring various treatment agents. In addition, the present invention enables cutting and observing cells in a living state.

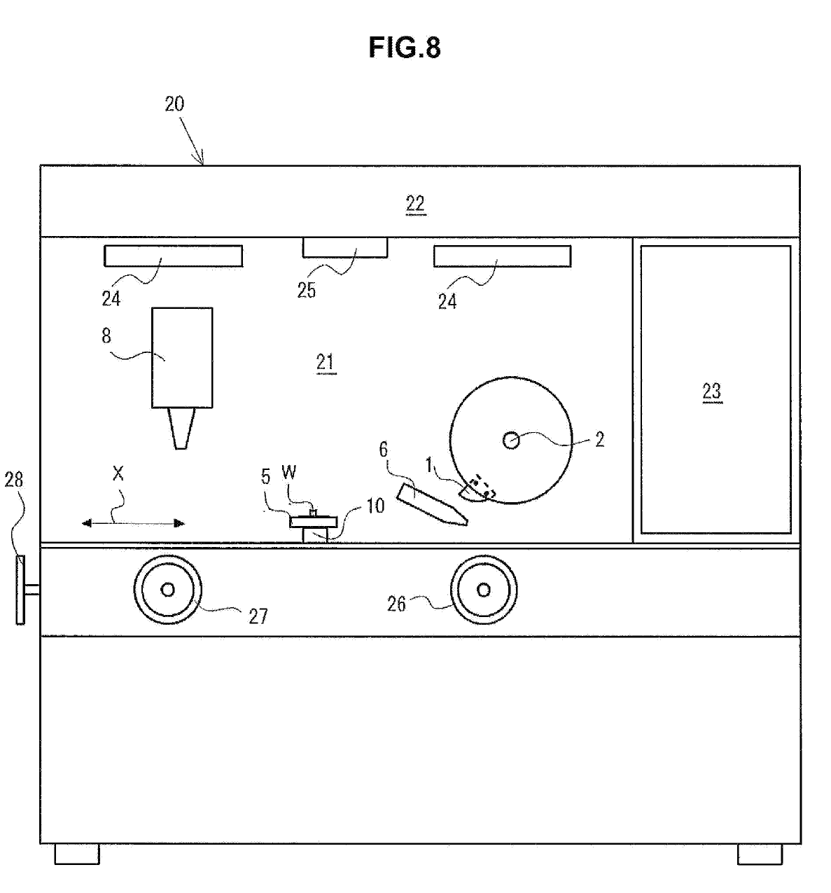

FIG. 8 shows a general front view of an example of an entire apparatus including a cutting apparatus for the method for cutting bipospecimen illustrated in FIGS. 7A-7B. A main part of the cutting apparatus as described above is provided in an operation space 21 in a sterile room such as a clean bench 20 shown in FIG. 8 or a glovebox. Operation with being blocked from surrounding environment is possible in the operation space 21. A vertically mobile sliding door is provided at the front of the clean bench 20 though not shown. Alternatively, gloves for operation may be provided at the front of the clean bench 20.

At the top of the apparatus, a HEPA filter may be provided for ventilation and for maintaining sterilized condition in the operation space 21. A UV lamp 24 and an ozone generator 25 are provided accordingly in the operation space 21.

The rotational axis member 2 of the cutting apparatus is provided in the right of the operation space 21 such that its height is adjustable. Rotation of a first manual cutting operation handle 26 provided outside the clean bench 20 is transmitted to rotation of the rotational axis member 2 via proper transfer mechanism. This handle is used when cutting is manually performed. The liquid nitrogen supplying device 6 is provided near the blade 1 such that its position is adjustable.

The liquid nitrogen dripping device 8 is provided in the left of the operation space 21 and its position in Y direction is adjustable by means of rotation of a second manual cutting operation handle 27 provided outside the clean bench 20.

The table 5 is moved in X and Y directions by controlling movement of a movable table 10 on which the table 5 is fixed with pneumatic chuck, etc. The movement of the movable table 10 is controlled by controlling of an electric motor with an operation panel 23 provided in the right end of operation space 21. The table 5 can be rotated in θ direction shown in FIGS. 7A-7B by rotating a handle 28 for operating θ angle of movable table provided outside the clean bench 20.

The operation panel 23 has on its outer surface operation buttons etc. for various setting in relation to running of the clean bench 20 and to the cutting apparatus. Inside the operation panel 23, electric equipment and control devices for an electric motor are contained.

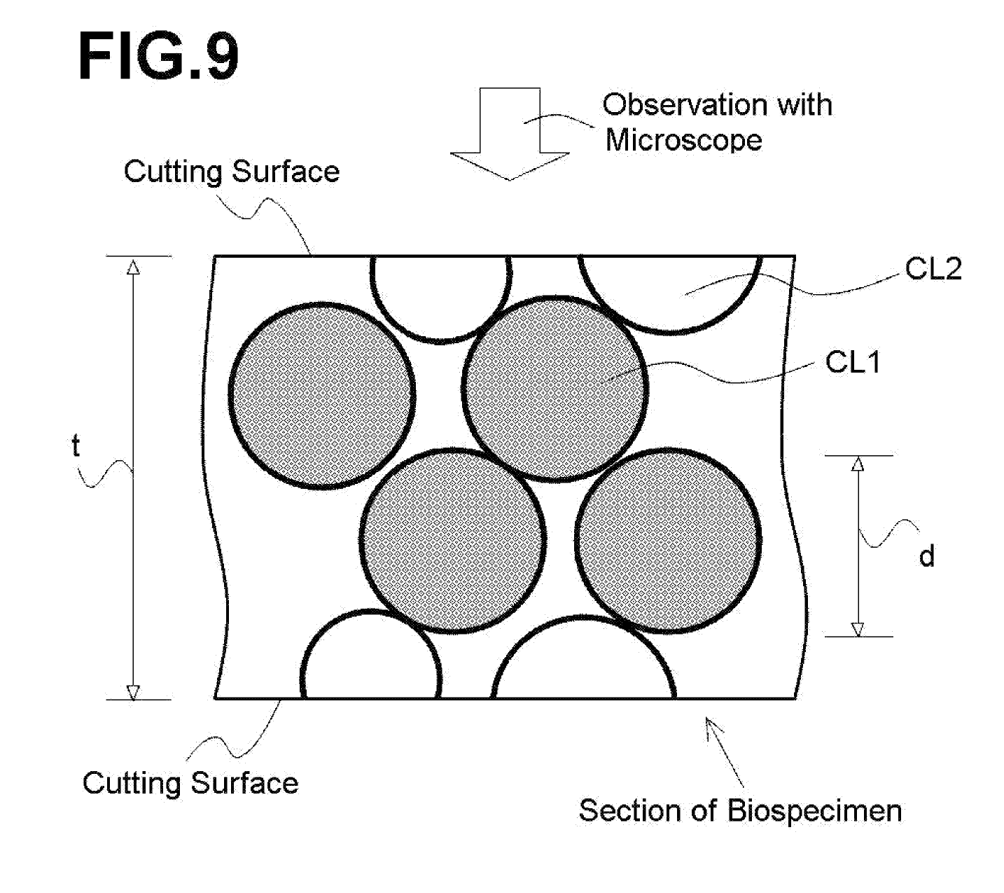

FIG. 9 shows a schematic side view illustrating a section of biospecimen cut out by using a cutting apparatus and a cutting method according to an embodiment of the present invention. The top and bottom surfaces shown in FIG. 9 are the cutting surfaces with the blade. The thickness t of the section is set as about 30 μm as one example. Reference symbols CL1, CL2 represent each one of the cells. In this example, the diameter d of a cell is around 10 μm. As to the cell CL2 on the cutting surface, a portion of which is cut away, it is found that only a cell membrane is left in it with the rest flowing out. In contrast, the cell CL1 in between two cutting surfaces is found preserved entirely. For example, by performing observation with a microscope, the cell CL1 that is preserved perfectly can be observed. And it is verified that the cell CL1 in this state maintains the state (position and function) when presented in an original living body. That is, it is identified as a living cell in which its position when it played a role to form tissues in a living body and its inherent functions such as proliferation, repair, metabolism, and transducing signals among cells are preserved intact.

As comparison examples, other cutting methods were tried, in which a straight blade or disc blade is used or a blade is moved linearly in a frozen and fixed workpiece. However, in these methods, cells in a section deformed and changed positions, or most of the cells were entirely damaged. In another case wherein a workpiece is placed on a board without freezing, it was not possible to cut into a section.

The cutting apparatus and cutting method according to the present invention is applicable to a biospecimen in which there is no necessity to preserve cells in a living state. In this case, keeping at supercool temperature is not necessary and a workpiece may be frozen and fixed by using other method than cryogenic liquid. For example, a workpiece may be frozen and fixed by cooling and freezing the coagulant described above (refer to the third related art).

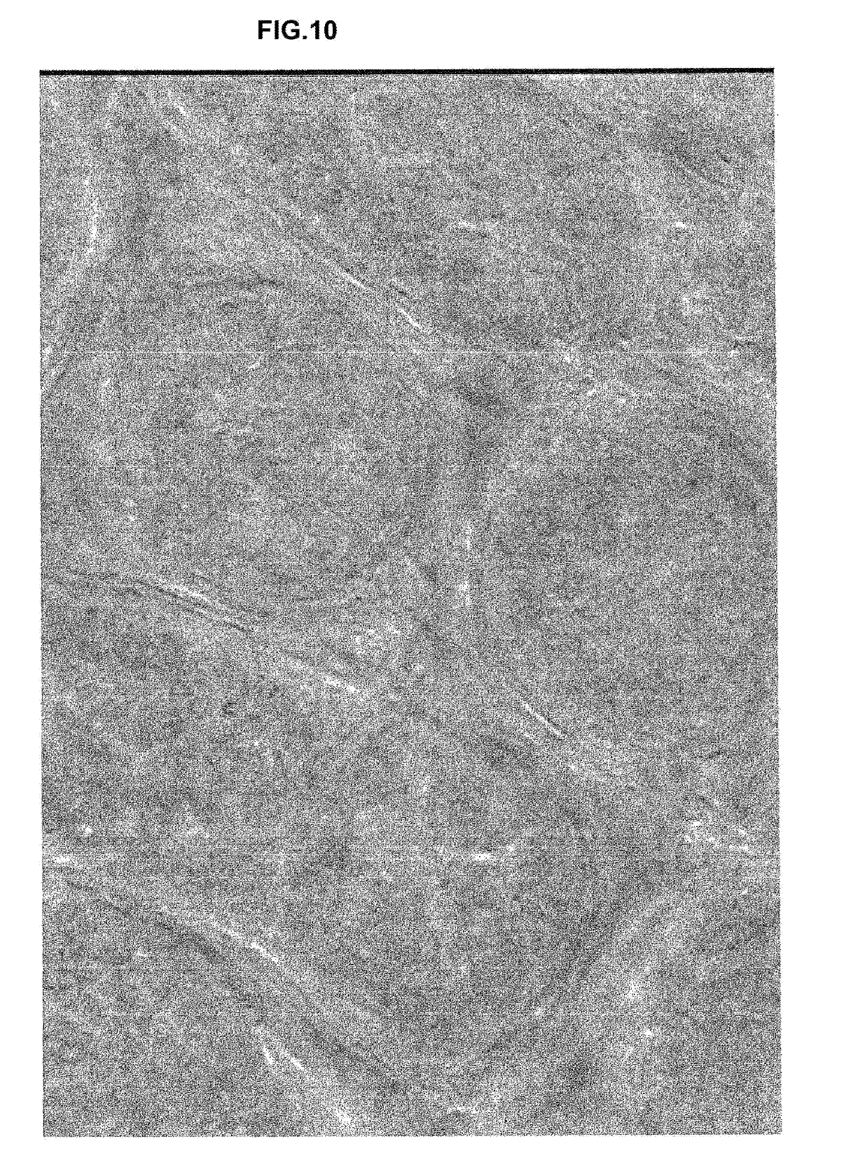

FIG. 10 shows a micrograph (400 times power) of a 25-μm-thick section cut out from a rat liver obtained with an apparatus according to an embodiment of the present invention. Respective cells are preserved in a state when they were in a living body.

The cutting apparatus and cutting method according to the present invention may be used to verify the state of cells as a result of experiment by applying to a biospecimen to which a desired experiment has been conducted. It is also possible, by using a section cut out from a biospecimen with the cutting apparatus and cutting method according to the present invention, to follow up a desired experiment or to produce a desired product with such section.

It is noted that embodiments of the present invention are not limited to the examples described with reference to drawings but may be modified in various aspects as long as it conforms to the subject of the present invention.

What is claimed is:

1. An apparatus for cutting a workpiece as biospecimen into a section comprising:
a board on which the workpiece is placed;
a device for freezing and fixing the workpiece on the board; and
a blade for cutting the frozen workpiece fixed on the board into a section by means of rotary movement in a predetermined rotational direction, and characterized in that:
a profile of a cutting edge of the blade is a curve starting at a nearest point from a rotational axis and ending at a farthest point from the axis wherein the distance from the axis to each of the points on the curve increases monotonically from the nearest point to the farthest point;
the farthest point is behind the nearest point in the rotational direction; and
the curve is convex opposite to the rotational axis with respect to a straight line connecting the nearest point and the farthest point.

2. The apparatus for cutting a biospecimen according to claim 1, wherein a cryogenic liquid is used in the device for freezing and fixing.

3. The apparatus for cutting a biospecimen according to claim 2, wherein the cryogenic liquid is liquid nitrogen.

4. The apparatus for cutting a biospecimen according to claim 2, wherein the cryogenic liquid is supplied to the workpiece during cutting operation with the blade.

5. The apparatus for cutting a biospecimen according to claim 4, wherein the cryogenic liquid is liquid nitrogen.

6. A method for cutting a workpiece as biospecimen into a section comprising the steps of:
placing the workpiece on a board;
freezing and fixing the workpiece on the board; and
cutting the frozen workpiece fixed on the board into a section by means of rotary movement of a blade in a predetermined rotational direction, characterized in that:
a profile of a cutting edge of the blade is a curve starting at a nearest point from a rotational axis and ending at a farthest point from the axis wherein the distance from the axis to each of the points on the curve increases monotonically from the nearest point to the farthest point;
the farthest point is behind the nearest point in the rotational direction; and
the curve is convex opposite to the rotational axis with respect to a straight line connecting the nearest point and the farthest point.

7. The method for cutting a biospecimen according to claim 6, wherein a cryogenic liquid is used in the device for freezing and fixing.

8. The method for cutting a biospecimen according to claim 7, wherein the cryogenic liquid is liquid nitrogen.

9. The method for cutting a biospecimen according to claim 7, wherein the cryogenic liquid is supplied to the workpiece during cutting operation with the blade.

10. The method for cutting a biospecimen according to claim 9, wherein the cryogenic liquid is liquid nitrogen.

11. The method of claim 10, further comprising observing cells contained in the section with a phase-contrast microscope while the section is immersed in a tissue culture growth medium.

12. The method of claim 6, further comprising observing cells contained in the section with a phase-contrast microscope while the section is immersed in a tissue culture growth medium.

13. The method for cell observation according to claim 12 further comprising the step of observing cells contained in the section with a phase-contrast microscope while continuing culture with the tissue culture growth medium containing the immersed section being kept in a carbogaseous incubator.

14. The method of claim 6, further comprising observing cells contained in the section, which are taken out from the tissue culture growth medium after immersion and then stained.

15. The method of claim 14, wherein a cryogenic liquid is used in the device for freezing and fixing.

16. The method of claim 15, wherein the cryogenic liquid is liquid nitrogen.
